(19) United States
(12) Patent Application Publication
(10) Pub. No.: US 2026/0172901 A1
(43) Pub. Date: Jun. 18, 2026

(54) DISAGGREGATED USER PLANE FUNCTION

(71) Applicant: Boost SubscriberCo L.L.C., Englewood, CO (US)

(72) Inventors: Borong Zheng, Littleton, CO (US); Dawood Shahdad, Aurora, CO (US)

(21) Appl. No.: 18/978,903

(22) Filed: Dec. 12, 2024

(51) Int. Cl. H04W 28/086; H04W 28/02

(52) U.S. Cl. CPC H04W 28/086; H04W 28/0268

(57) ABSTRACT

A disclosed method may include obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network, deploying the UPF-core in a centralized location, and deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

### BRIEF SUMMARY

This disclosure is generally directed to systems, methods, and computer-readable media relating to a disaggregated user plane function. Mobile network operators may face various challenges in deploying and managing user plane functions (UPFs) in enterprise environments, particularly as networks evolve towards 5G and beyond. One such challenge may be the efficient allocation of computing resources for UPF deployment in enterprise settings. Some UPF embodiments may utilize significant computing power, which may not always be readily available or cost-effective to deploy on-premises at enterprise locations. This situation may be further complicated by the diverse preferences of different enterprise customers, ranging from small businesses with limited network requests to large corporations demanding high-performance, low-latency services. The variability in enterprise requirements may make it difficult for network operators to provide a one-size-fits-all solution for UPF deployment, potentially leading to overprovisioning in some cases and underperformance in others. Additionally, the desire to support multiple network technologies alongside newer 5G capabilities may add another layer of complexity to UPF deployment strategies, as operators may factors relating to seamless integration and compatibility across multiple network generations. In some scenarios, the deployment of full-fledged UPF instances at each enterprise site may result in underutilized resources, especially for smaller businesses with fluctuating network demands. Conversely, larger enterprises with high-traffic volumes and stringent performance specifications may find that some UPF deployments struggle to meet their corresponding demands during peak usage periods. This disparity in resource utilization and performance may lead to inefficiencies in network management and potentially impact the overall quality of service provided to enterprise customers. Furthermore, the static nature of some UPF deployments may limit the ability of network operators to quickly adapt to changing enterprise needs or to scale their services efficiently across a diverse customer base.

A technique for optimizing UPF deployment in enterprise environments may involve partitioning UPF functionality between a centralized UPF-core and distributed UPF-mini instances, as discussed further below. This technique may enable more efficient use of computing resources by centralizing less latency-sensitive functions in the UPF-core while deploying more time-sensitive functions in UPF-mini instances at enterprise premises. The UPF-core may be deployed in a cloud environment or a centralized data center, leveraging economies of scale and shared resources to handle functions such as subscriber database management, Quality of Service (QoS) policy management, and charging and billing operations. Meanwhile, UPF-mini instances may be deployed on System-on-Chip (SoC) devices at enterprise locations, focusing on latency-sensitive such as packet forwarding, traffic shaping, and real-time QoS enforcement. This distributed architecture may offer several potential benefits, including improved resource utilization, reduced on-premises hardware requirements, and the ability to scale UPF capabilities more flexibly across diverse enterprise deployments. By centralizing certain functions, network operators may also gain better visibility and control over network-wide policies and performance, potentially simplifying management and troubleshooting processes. In some embodiments, the UPF-core may dynamically allocate resources to UPF-mini instances based on real-time traffic patterns and enterprise-specific requirements, potentially optimizing network performance and resource utilization across the entire network. This flexible allocation may enable network operators to efficiently support a wide range of enterprise customers with varying needs, from small businesses with minimal network requirements to large corporations with demanding performance expectations. The UPF-core may also serve as a centralized point for software updates and policy management, enabling network operators to rapidly deploy new features or security patches across all UPF-mini instances without requests for on-site interventions. This centralized management capability may significantly reduce operational overhead and improve the agility of enterprise network services.

Another significant challenge in UPF deployment for enterprise 5G networks may be facilitating consistent quality of service (QoS) and meeting stringent performance requests across diverse enterprise environments. Different enterprises may have varying requests in terms of network capacity, latency, reliability, and security, making it difficult to provide a standardized UPF solution that meets all these requirements effectively. Moreover, as enterprises increasingly rely on applications and services that demand ultra-low latency and high reliability, the pressure on UPF performance may intensify. Some centralized UPF architectures may struggle to meet these demands, particularly in scenarios where enterprises are geographically distant from core network facilities. The challenge may be further compounded by the desire to support a wide range of devices and use cases, from IoT sensors with minimal bandwidth requirements to high-definition video conferencing systems that demand substantial network resources. Balancing these diverse needs while maintaining overall network efficiency and cost-effectiveness may present a significant hurdle for network operators seeking to expand their enterprise 5G offerings. In some cases, the inability to provide tailored QoS policies for specific enterprise applications or network slices may result in suboptimal performance for certain services, potentially impacting business operations and user satisfaction. Additionally, the dynamic nature of enterprise network traffic, with potential spikes during certain times of day or during specific events, may benefit from a level of flexibility and responsiveness that some static UPF deployments may not provide. The challenge of maintaining consistent QoS across geographically distributed enterprise sites may also be exacerbated by variations in local network conditions and the potential for congestion in shared network segments.

A technique to address these QoS and performance challenges may lie in the embodiment of a hybrid UPF architecture that combines centralized management with distributed processing capabilities. In this technique, the UPF-core deployed in a centralized location may handle global policy management, performance monitoring, and coordination of network-wide resources. This centralized component may leverage advanced analytics and machine learning algorithms to dynamically optimize QoS policies based on real-time network conditions and enterprise-specific requirements. Meanwhile, UPF-mini instances deployed at enterprise premises may focus on executing these policies and performing latency-sensitive functions. This distributed processing may help reduce end-to-end latency for time-sensitive applications and services, potentially improving overall user experience. The UPF-mini instances may also be customized to meet specific enterprise needs, with the ability to prioritize certain types of traffic or allocate resources to particular applications as needed. By combining centralized intelligence with localized processing, this hybrid architecture may offer a flexible and scalable solution for meeting diverse QoS requirements across different enterprise deployments. Additionally, this technique may provide network operators with greater agility in responding to changing enterprise preferences, enabling rapid deployment of new services or adjustments to existing ones without extensive changes to the underlying network infrastructure. In some embodiments, the UPF-core may continuously analyze traffic patterns and application performance metrics across all enterprise deployments, using this data to refine and optimize QoS policies in real-time. This adaptive technique may enable network operators to proactively address potential performance issues before they impact enterprise operations, potentially improving overall service reliability and customer satisfaction. The hybrid architecture may also facilitate the embodiment of advanced network slicing capabilities, enabling network operators to create and manage multiple virtual networks with distinct QoS characteristics over the same physical infrastructure, further enhancing their ability to meet diverse enterprise requirements.

Security and data privacy considerations may present another significant challenge in the deployment of UPFs for enterprise 5G networks. As enterprises increasingly rely on mobile networks for operations and sensitive data transmission, robust security measures become more relevant. Some UPF architectures may face limitations in providing enterprise-specific security policies and may not always offer the level of isolation and control that some businesses seek. Moreover, with the evolving threat landscape and regulatory requirements, network operators may benefit from continuously updating and enhancing their security capabilities to protect against vulnerabilities and comply with data protection standards. The challenge may be further complicated by the need to balance strong security measures with performance requirements, as some restrictive security policies may potentially impact network latency and throughput. Additionally, in multi-tenant enterprise environments or shared network infrastructures, maintaining strict data separation and preventing unauthorized access between different enterprise customers may pose significant technical and operational challenges. In some scenarios, the centralized nature of some UPF deployments may create a single point of failure or attack, potentially increasing the risk of widespread service disruptions or data breaches. Furthermore, the diverse nature of enterprise security requirements, ranging from basic firewalling to advanced threat detection and prevention capabilities, may benefit from a more flexible and customizable technique to UPF security that some architectures may not readily provide. The challenge of implementing consistent security policies across geographically distributed enterprise sites while maintaining local compliance with regional data protection regulations may also add complexity to UPF security management.

A technique to address these security and privacy concerns may involve the embodiment of a distributed UPF architecture with enhanced security features. In this technique, the UPF-core may serve as a centralized security policy manager, defining and distributing enterprise-specific security rules and protocols to UPF-mini instances deployed at enterprise premises. These UPF-mini instances may then enforce these security policies locally, potentially providing a first line of defense against security threats. This distributed security model may offer several advantages, including the ability to implement customized security measures for each enterprise, reduced latency in security policy enforcement, and improved isolation between different enterprise networks. The UPF-mini instances may be equipped with advanced packet inspection capabilities, enabling real-time threat detection and mitigation at the network edge. Furthermore, the communication between UPF-core and UPF-mini instances may be secured using strong encryption and authentication mechanisms, helping to protect against man-in-the-middle attacks and unauthorized access. This technique may also facilitate compliance with data localization requirements by enabling sensitive data processing to occur within enterprise premises while still enabling centralized management and oversight. By combining centralized security intelligence with distributed enforcement, this technique may offer a flexible and robust security framework that may adapt to the evolving threat landscape and meet the diverse security needs of different enterprise customers. In some embodiments, the UPF-core may leverage machine learning algorithms to analyze network traffic patterns and security events across all enterprise deployments, potentially enabling proactive threat detection and automated response mechanisms. This adaptive security technique may enable network operators to stay ahead of emerging threats and continuously enhance their security posture without manual intervention or disrupting enterprise operations. The distributed nature of this security architecture may also provide enhanced resilience against large-scale attacks, as compromising a single UPF-mini instance may not necessarily lead to a breach of the entire network.

In some examples, a method includes obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network, deploying the UPF-core in a centralized location, and deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

In some examples, the method further comprises deploying the UPF-core on-premises at the enterprise premises such that both the UPF-core and UPF-mini are located at the enterprise premises.

In some examples, the method further comprises deploying the UPF-core in a cloud computing environment such that the UPF-core operates as a virtualized network function.

In some examples, the method further comprises implementing a secure communication channel between the UPF-core and the UPF-mini through at least one of gRPC, Unix Socket APIs, HTTP/2, or VPN overlays.

In some examples, the method further comprises utilizing the secure communication channel to synchronize configuration data between the UPF-core and the UPF-mini.

In some examples, the method further comprises employing the secure communication channel to transmit performance metrics or fault data from the UPF-mini to the UPF-core for centralized analysis.

In some examples, the method further comprises implementing a database management system in the UPF-core that stores or manages subscriber or session-related data for multiple UPF-minis.

In some examples, the method further comprises centralizing Quality of Service (QoS) policy management in the UPF-core such that a QoS rule is distributed to multiple UPF-minis for enforcement.

In some examples, the method further comprises a centralized charging or billing system in the UPF-core that collects usage data from multiple UPF-minis and interfaces with a Charging Function (CHF).

In some examples, the method further comprises deploying a performance management system in the UPF-core that monitors a performance metric from multiple UPF-minis for analysis and troubleshooting.

In some examples, the method further comprises implementing a fault management system in the UPF-core that tracks or manages a set of errors, outages, or faults that is reported from a set of multiple UPF-minis.

In some examples, the method further comprises centralizing configuration management in the UPF-core such that configuration parameters are distributed to multiple UPF-minis.

In some examples, the method further comprises implementing a data forwarding or routing function in the UPF-mini such that delay in user traffic delivery is reduced.

In some examples, the method further comprises implementing a Quality of Service (QoS) enforcement function in the UPF-mini such that traffic is prioritized based on a service requirement.

In some examples, the method further comprises implementing a traffic shaping or rate limiting function in the UPF-mini such that data flow or match bandwidth allowances are controlled.

In some examples, the method further comprises implementing a packet inspection or filtering function in the UPF-mini such that deep packet inspection is performed for security, compliance, or service-based filtering.

In some examples, a non-transitory computer-readable medium has instructions stored thereon that, when executed by at least one physical computing processor, cause a computing device to perform operations comprising obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network, deploying the UPF-core in a centralized location, and deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

In some examples, a system comprises a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network. In this system, the UPF-core may be deployed in a centralized location and the UPF-mini may be deployed on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

### BRIEF DESCRIPTION OF THE DRAWINGS

For a better understanding of the present invention, reference will be made to the following Detailed Description, which is to be read in association with the accompanying drawings:

FIG. 1 shows an example flow diagram illustrating a method for deploying a partitioned User Plane Function (UPF) in an enterprise 5G network.

FIG. 2 illustrates an example deployment architecture of UPF-core and UPF-mini components in a 5G network environment.

FIG. 3 depicts an example multi-panel illustration showing the deployment of UPF-core and UPF-mini in an enterprise network setting.

FIG. 4 presents an example illustration focusing on the internal architecture and functions of the UPF-core and UPF-mini.

FIG. 5 shows an example detailed illustration of the secure communication channel between the UPF-core and UPF-mini, highlighting various communication protocols and security measures.

FIG. 6 illustrates an example of the UPF-mini's integration with RAN components on the System-on-Chip (SoC) and its real-time processing capabilities.

FIG. 7 depicts an example of the centralized management functions of the UPF-core and its interaction with multiple UPF-mini instances.

FIG. 8 presents an example illustration focusing on the real-time processing capabilities of the UPF-mini, highlighting its interaction with user equipment and the benefits of its integration with RAN components on the SoC.

FIG. 9 shows an example illustration combining real-world elements with schematic representations to show the interaction between the UPF-core and multiple UPF-mini instances across different enterprise deployments.

FIG. 10 depicts a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

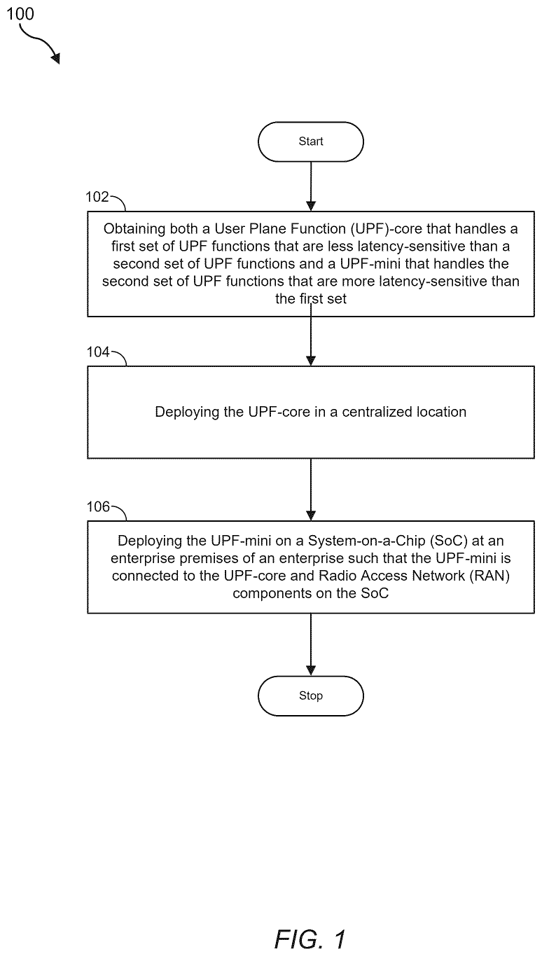

FIG. 1 shows a flow diagram for a method 100 relating to deploying a partitioned User Plane Function (UPF) in an enterprise 5G network. At step 102, the method includes obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation (5G) cellular network. At step 104, the method involves deploying the UPF-core in a centralized location. At step 106, the method includes deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation (5G) cellular service to the enterprise. As used herein, the term “centralized location” may generally refer to a centralized location other than the SoC such that the UPF is disaggregated and the overall inventive concept and benefits of this disclosure are maintained. As used herein, the terms “UPF-core” and “UPF-mini” may generally refer to disaggregated subsets of the UPF consistent with the overall inventive concept described in this disclosure.

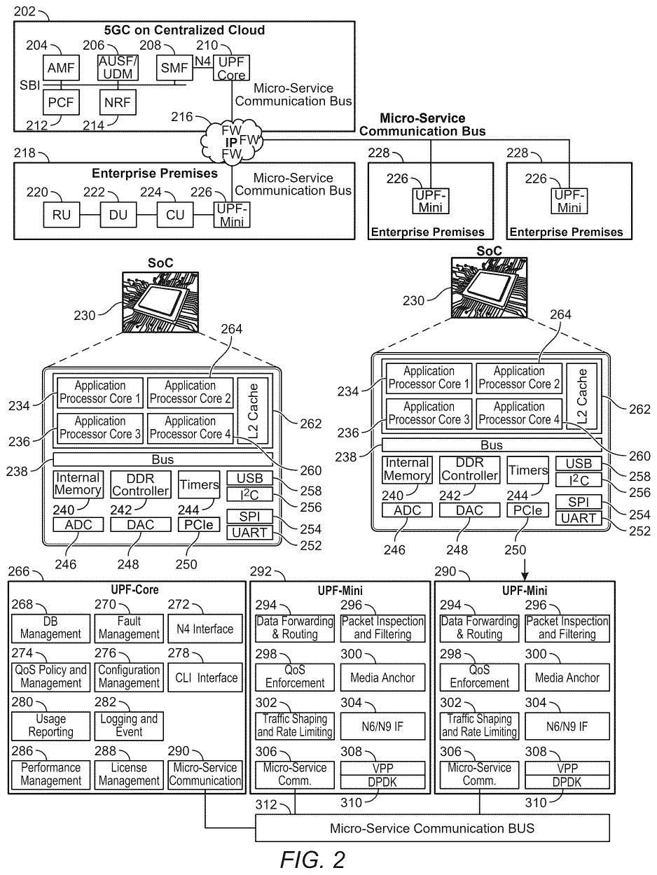

FIG. 2 shows a comprehensive example illustration of a distributed User Plane Function (UPF) architecture for enterprise 5G networks. The figure is divided into three sections: top, middle, and bottom, each depicting different aspects of the system. This representation provides a visualization of how various components interact across different levels of the network architecture, from the centralized cloud to the enterprise premises and down to the individual chip level.

The top section of FIG. 2 illustrates the 5G Core (5GC) on centralized cloud 202. This centralized cloud environment houses several components of the example 5GCnetwork, each playing a distinct role in the overall functionality of the system. The Access and Mobility Management Function (AMF) 204 is shown, which may handle tasks related to access control and mobility management. In some embodiments, AMF 204 may be responsible for user authentication, authorization, and managing the mobility of user equipment across the network. Adjacent to AMF 204 is the Authentication Server Function/Unified Data Management (AUSF/UDM) 206, which may handle authentication processes and manage subscriber data. AUSF/UDM 206 may serve dual roles in the network architecture. The AUSF component may be responsible for authenticating user devices and providing security credentials, potentially enhancing the overall security of the network. Meanwhile, the UDM component may act as a centralized repository for user profiles, subscription information, and network policies. This combination of authentication and data management functions in a single entity may streamline user access control and policy enforcement, potentially enabling more efficient and secure network operations. The integration of these functions may also facilitate seamless coordination between authentication processes and user data retrieval, which may be particularly beneficial in scenarios requiring rapid user authentication and personalized service delivery.

The Session Management Function (SMF) 208 is depicted, connected to the UPF core 210 via an N4 interface. This connection may facilitate the control and management of user sessions, enabling dynamic allocation of network resources based on user needs and network conditions. SMF 208 may work in conjunction with UPF core 210 to establish, modify, and terminate user sessions, ensuring optimal use of network resources. The Policy Control Function (PCF) 212 and Network Repository Function (NRF) 214 are also illustrated, which may handle policy decisions and network function discovery, respectively. PCF 212 may provide a unified policy framework for the entire network, potentially enabling consistent application of rules and Quality of Service (QoS) parameters across different network slices and services. NRF 214 may maintain a registry of available network functions, facilitating service discovery and load balancing within the network.

These components are interconnected across a micro-service communication bus labeled as Service-Based Interface (SBI), which may enable efficient communication and data exchange between different network functions. The SBI may provide a flexible and scalable architecture, enabling easy integration of new services and functions as the network evolves. This micro-service-based technique may offer benefits such as improved modularity, easier updates and maintenance, and better resource utilization compared to monolithic architectures.

At the bottom of the centralized cloud 202, an IP firewall 216 is shown. This firewall may provide security and access control between the centralized cloud and the enterprise premises, potentially protecting sensitive core network functions from unauthorized access or cyber threats. The IP firewall 216 may implement advanced security policies, potentially including deep packet inspection, intrusion detection and prevention, and application-level filtering to ensure the integrity and confidentiality of network communications.

Below the IP firewall 216, another micro-service communication bus connects to multiple enterprise premises: enterprise premises 218 and two instances of enterprise premises 228. This distributed architecture may enable efficient distribution of network functions closer to the end-users, potentially reducing latency and improving overall network performance. Enterprise premises 218 includes several components: Radio Unit (RU) 220, Distributed Unit (DU) 222, Centralized Unit (CU) 224, and UPF-mini 226. These components may work together to provide radio access and user plane functionality at the enterprise level. RU 220 may handle the actual radio transmission and reception, while DU 222 and CU 224 may manage lower-layer and higher-layer processing of the radio access network protocols, respectively. UPF-mini 226 may handle localized user plane processing, potentially enabling low-latency services for enterprise users.

Both instances of enterprise premises 228 include UPF-mini 226, which may handle localized user plane processing. This replication of UPF-mini across different enterprise premises may demonstrate the scalability and flexibility of the architecture, potentially enabling network operators to deploy consistent user plane functionality across diverse enterprise environments. The presence of multiple UPF-mini instances may also provide redundancy and load balancing capabilities, potentially improving the overall reliability and performance of the network.

In some examples, the distributed architecture illustrated in the top section of FIG. 2 may align with the deployment of UPF-core in a centralized location and a UPF-mini on enterprise premises. The centralized cloud 202 may host the UPF-core 210, while the enterprise premises (218 and 228) may host the UPF-mini 226 instances. This distribution may enable the system to balance centralized management and control with localized, low-latency processing at the enterprise level.

The middle section of FIG. 2 depicts two instances of System-on-Chip (SoC) 230. Each SoC includes four application processor cores: Core 1 234, Core 2 264, Core 3 236, and Core 4 260 and/or an L2 cache 262. These cores may handle various processing tasks within the SoC, potentially enabling for parallel processing of different UPF-mini functions. The multiple cores may enable efficient distribution of workloads, potentially improving overall system performance and responsiveness. The SoC also includes an internal bus 238 for internal communication, which may facilitate rapid data exchange between different components of the chip. Internal memory 240 may provide local data storage, potentially reducing the need for frequent access to external memory and improving processing speed for frequently used data.

A DDR controller 242 is shown, which may manage external memory interfaces, potentially enabling the SoC to access larger amounts of memory when needed for more data-intensive operations. Various peripheral interfaces are illustrated, including timers 244, USB 258, I²C 256, SPI 254, UART 252, ADC 246, DAC 248, and PCIe 250. These interfaces may enable the SoC to communicate with external devices and sensors, providing flexibility in system design and integration. For example, the USB 258 and PCIe 250 interfaces may enable high-speed connections to external storage or networking devices, while the ADC 246 and DAC 248 may enable integration with analog sensors or actuators in industrial IoT applications.

In some examples, the SoC architecture illustrated in the middle section of FIG. 2 may correspond to the deployment of UPF-mini on a System-on-a-Chip (SoC) at an enterprise premises. The multiple application processor cores (234, 264, 236, 260) may enable efficient distribution of UPF-mini functions, potentially enabling real-time processing of user plane data. This multi-core architecture may be particularly beneficial for handling latency-sensitive tasks such as packet forwarding and QoS enforcement. The various interfaces and controllers within the SoC may facilitate integration with RAN components and other network elements, supporting the claim language regarding integration of UPF-mini with RAN components on the SoC. For instance, the PCIe interface 250 may provide a high-speed connection to external RAN components, while the internal bus 238 may enable efficient communication between UPF-mini functions and on-chip RAN processing elements.

The bottom section of FIG. 2 provides a detailed view of the UPF-core 266 and two instances of UPF-mini (292 and 290). UPF-core 266 includes several components that may handle less latency-sensitive functions: database management 268, fault management 270, N4 interface 272, Quality of Service (QoS) policy and management 274, configuration management 276, CLI interface 278, usage reporting 280, logging and event 282, performance management 286, license management 288, and micro-service communication 290. These components align with the UPF-core handling a first set of UPF functions that are less latency-sensitive.

The database management 268 and fault management 270 components may provide overall control and monitoring of the UPF-core operations, potentially including fault detection and recovery mechanisms. The N4 interface 272 may facilitate communication with the SMF, enabling dynamic control of user plane functions. Quality of Service (QoS) policy and management 274 may define and enforce network-wide QoS policies, potentially ensuring consistent service levels across different enterprise deployments. Configuration management 276 may handle the setup and ongoing maintenance of UPF parameters, potentially enabling centralized control of distributed UPF-mini instances.

The CLI interface 278 may provide a command-line interface for network administrators to manage and troubleshoot the UPF-core, while usage reporting 280 may collect and aggregate data on network usage for billing and capacity planning purposes. Logging and event 282 and performance management 286 may work together to monitor the health and efficiency of the UPF-core, potentially enabling proactive maintenance and optimization. License management 288 may handle software licensing for the UPF components, potentially ensuring compliance and enabling feature activation based on service agreements. The micro-service communication 290 component may facilitate interaction between different UPF-core functions and with external network elements, potentially enabling a modular and scalable architecture.

UPF-mini 292 (and its counterpart micro-service communication 290) includes components for more latency-sensitive functions: data forwarding and routing 294, packet inspection and filtering 296, Quality of Service (QoS) enforcement 298, media anchor 300, traffic shaping and rate limiting 302, N6/N9 interface 304, micro-service communication 306, Vector Packet Processing (VPP) 308, and Data Plane Development Kit (DPDK) 310. These examples of illustrative components may correspond to the UPF-mini handling a second set of UPF functions that are more latency-sensitive than the first set.

The data forwarding and routing 294 component may handle the rapid transmission of user data packets, potentially utilizing hardware acceleration for improved performance. Packet inspection and filtering 296 may examine packet contents in real-time, potentially enabling advanced security features and application-aware networking. Quality of Service (QoS) enforcement 298 may apply QoS policies at the packet level, ensuring that high-priority traffic receives appropriate treatment. The media anchor 300 may handle media-specific processing, potentially optimizing the delivery of real-time audio and video streams.

Traffic shaping and rate limiting 302 may control the flow of data to prevent network congestion and ensure fair resource allocation among users. The N6/N9 interface 304 may provide connectivity to external data networks and other UPF instances, respectively. The micro-service communication 306 component may enable interaction between different UPF-mini functions and with the UPF-core 266, potentially enabling dynamic reconfiguration and updates.

Vector Packet Processing (VPP) 308 and Data Plane Development Kit (DPDK) 310 are software frameworks that may enhance the packet processing capabilities of the UPF-mini. VPP 308 may provide a high-performance, extensible framework for packet processing, while DPDK 310 may offer a set of libraries and drivers for fast packet processing, potentially enabling the UPF-mini 290 to handle high traffic volumes with low latency.

In some examples, the division of functions between UPF-core 266 and UPF-mini instances 290 and 292, as illustrated in FIG. 2, may demonstrate the partitioning of a UPF of at least a fifth-generation cellular network. The UPF-core 266, with its less latency-sensitive functions, may be deployed in a centralized location (such as the centralized cloud 202 shown in the top section), while the UPF-mini instances (292 and 290) may be deployed on SoCs at enterprise premises, aligning with the described deployment strategy. This partitioning may enable efficient resource utilization, with computationally intensive but less time-sensitive tasks handled centrally, and latency-sensitive functions processed closer to the end-users.

The micro-service communication bus 312 connecting the UPF-mini instances may facilitate the integration of a UPF-mini with the UPF-core and RAN components. This integration may enable the provision of at least fifth-generation cellular service to the enterprise, leveraging the distributed architecture to balance centralized management with localized, low-latency processing. The micro-service communication bus 312 may provide a flexible and scalable means of interconnecting various UPF-mini instances, potentially enabling dynamic reconfiguration of the network based on changing enterprise needs or traffic patterns.

In some examples, the architecture illustrated in FIG. 2 may provide several benefits for enterprise 5G deployments. The separation of UPF functions between a centralized UPF-core 266 and distributed UPF-mini instances 292 and 290 may enable more efficient resource utilization, potentially reducing the overall cost of deployment while maintaining high performance. The use of SoC technology for UPF-mini deployment may enable compact, power-efficient installations at enterprise premises, potentially simplifying network expansion and reducing infrastructure footprint. The integration of UPF-mini with RAN components on the SoC 230 may reduce communication latency between these elements, potentially enabling new use cases that require ultra-low latency, such as industrial automation or augmented reality applications.

Furthermore, the flexible nature of this architecture may enable network operators to tailor their deployments to specific enterprise needs. For example, enterprises with high security requirements may benefit from the local processing capabilities of the UPF-mini, keeping sensitive data within the premises, while still leveraging centralized management and policy control through the UPF-core 266. The scalability of this technique may also enable seamless network expansion, with additional UPF-mini instances easily integrated into the existing framework as enterprise needs grow or new sites are added.

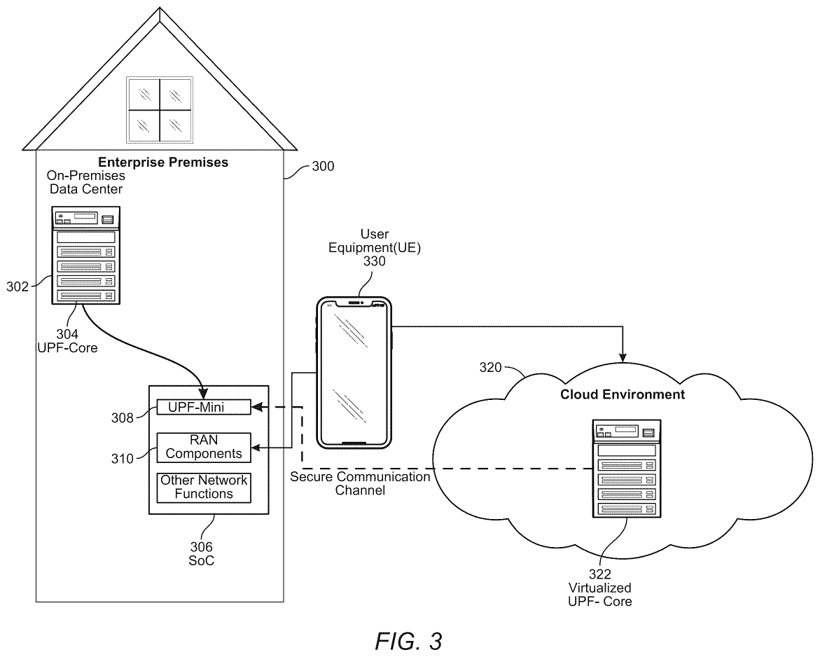

FIG. 3 illustrates an example comprehensive deployment architecture for UPF-core and UPF-mini components in an enterprise 5G network environment. The figure presents a single, comprehensive panel that captures both on-premises and cloud deployment scenarios, showcasing the flexibility and scalability of the UPF architecture.

On the left side of FIG. 3, a large rectangular building outline labeled “Enterprise Premises 301” is shown. This representation may symbolize a typical enterprise location where 5G network services are implemented. Within the Enterprise Premises 301, in the upper left corner, a tall rectangular shape represents a server rack, labeled “On-Premises Data Center 302”. This on-premises data center may house various network components and computing resources that support the enterprise's 5G infrastructure.

Inside the On-Premises Data Center 302, a smaller rectangle representing a server is labeled “UPF-Core 304”. This UPF-Core 304 may represent an on-premises deployment of the UPF-core, which may handle less latency-sensitive functions of the User Plane Function. The placement of UPF-Core 304 within the enterprise premises may offer benefits such as reduced latency for certain operations and potentially enhanced data privacy, as sensitive information may be processed locally.

In the lower right corner of the Enterprise Premises 301, a large square shape representing a System-on-Chip is labeled “SoC 306”. This SoC 306 may integrate multiple network functions into a single, compact device, potentially reducing hardware footprint and improving energy efficiency. Inside SoC 306, three smaller rectangles are arranged vertically, labeled from top to bottom: “UPF-Mini 308”, “RAN Components 310”, and “Other Network Functions”. The UPF-Mini 308 may handle real-time, latency-sensitive UPF tasks, while RAN Components 310 may manage radio access network functions. The unlabeled “Other Network Functions” rectangle may represent additional network capabilities integrated into the SoC.

A thick arrow is drawn from UPF-Core 304 to UPF-Mini 308, curving or bending to clearly show the connection between these components. This connection may enable the UPF-Core to manage and coordinate the activities of the UPF-Mini, potentially enabling centralized control while maintaining the benefits of distributed processing.

On the right side of the figure, a large cloud shape is labeled “Cloud Environment 320”. This cloud environment may represent a centralized, off-premises location where certain network functions are hosted. Inside Cloud Environment 320, a server icon similar to UPF-Core 304 is labeled “Virtualized UPF-Core 322”. This virtualized UPF-Core 322 may perform similar functions to the on-premises UPF-Core 304, but in a cloud-based, virtualized environment.

Another thick arrow, styled differently (i.e., dashed line) and longer than the one connecting the on-premises UPF-Core 302, is drawn from Virtualized UPF-Core 322 to UPF-Mini 308 in SoC 306. Above this arrow, a text label reads “Secure Communication Channel”. This secure channel may enable encrypted, low-latency communication between the cloud-based core and the on-premises mini UPF, potentially balancing the benefits of centralized management with local processing.

In the space between Enterprise Premises 301 and Cloud Environment 320, a simplified smartphone or tablet device is labeled “User Equipment (UE) 330”. Two thin arrows are drawn from UE 330: one pointing to RAN Components 310 in the SoC 306, and another pointing to Cloud Environment 320. These arrows may represent the UE's connections to both local and cloud resources, illustrating the potential for seamless integration of on-premises and cloud-based network functions.

In some examples, this architecture may offer several potential benefits for enterprise 5G deployments. The flexibility to deploy UPF-core either on-premises (UPF-Core 304) or in a cloud environment (Virtualized UPF-Core 322) may enable network operators to choose the most suitable configuration based on specific enterprise preferences, regulations, or existing infrastructure. This adaptability may be particularly valuable as enterprises transition towards more advanced 5G use cases, enabling them to balance performance, cost, and compliance considerations.

In some scenarios, the integration of the UPF-mini with RAN components on a single SoC (as shown in SoC 306) may enable efficient, low-latency processing of user plane data at the enterprise edge. This integration may be particularly beneficial for applications involving ultra-low latency or high bandwidth, such as industrial automation, augmented reality, or large-scale IoT deployments. By processing data locally on the SoC 306, these applications may achieve faster response times and more consistent performance compared to architectures that rely heavily on centralized processing.

The secure communication channel between the UPF-core (either on-premises or virtualized) and the UPF-mini may ensure that sensitive control data and policies can be safely exchanged, even when the core is deployed in a public cloud environment. This security feature may be helpful for enterprises with strict data protection rules or those operating in regulated industries. Additionally, the ability to maintain local processing capabilities through the UPF-mini while leveraging cloud resources for less latency-sensitive tasks may provide a balanced technique to network deployment, potentially offering the benefits of edge computing alongside the scalability and management advantages of cloud infrastructure.

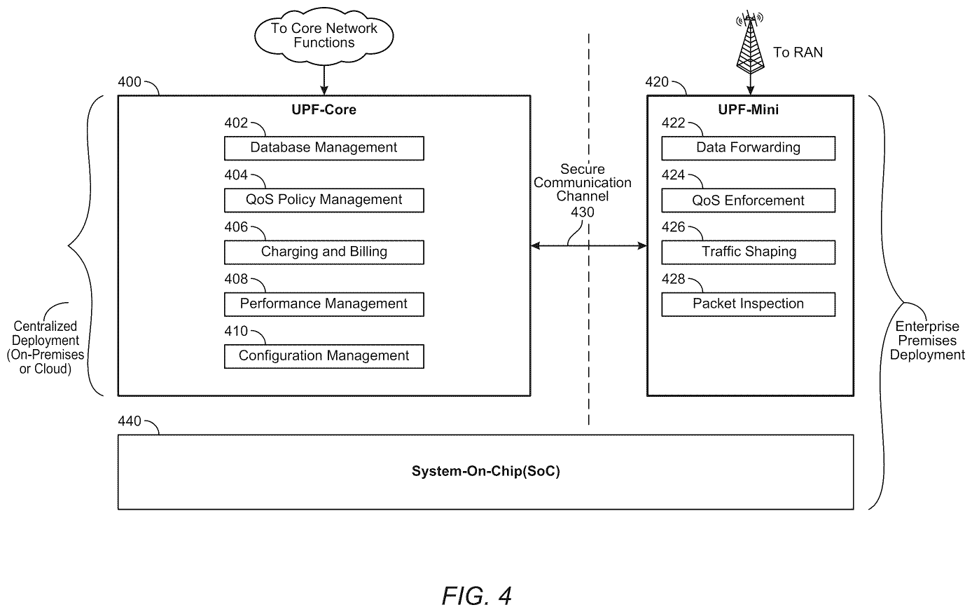

FIG. 4 illustrates a detailed view of the internal architecture and functions of the UPF-core and UPF-mini components in a 5G network deployment. The figure is divided into two main sections: the left for the UPF-core and the right for the UPF-mini, separated by a vertical dashed line.

On the left side of FIG. 4, a large rectangle labeled “UPF-Core 400” may represent the centralized component of the User Plane Function, which may handle less latency-sensitive tasks. Inside UPF-Core 400, five smaller rectangles are arranged vertically, each representing a specific function. From top to bottom, these functions are labeled: “Database Management 402”, “QoS Policy Management 404”, “Charging and Billing 406”, “Performance Management 408”, and “Configuration Management 410”. These components may work together to provide comprehensive management and control of the overall UPF system.

In some examples, the Database Management 402 function may be responsible for storing and managing subscriber data, session information, and/or other relevant network data. This centralized database management may enable efficient data retrieval and updates across the entire network. The QoS Policy Management 404 function may define, store, and distribute Quality of Service (QoS) policies throughout the network. By centralizing this function, network operators may achieve consistent QoS enforcement across multiple UPF-mini instances and enterprise deployments.

The Charging and Billing 406 function within the UPF-Core 400 may handle the collection and processing of usage data for billing purposes. This centralized technique to charging and billing may simplify accounting processes and provide a unified view of network usage across multiple enterprise deployments. Performance Management 408 may monitor and analyze the performance of both the UPF-core 400 and distributed UPF-mini 420 instances, potentially enabling proactive optimization of network resources. The Configuration Management 410 function may manage the configuration settings for all UPF components.

On the right side of FIG. 4, another large rectangle labeled “UPF-Mini 420” may represent the distributed component of the User Plane Function, designed to handle real-time, latency-sensitive tasks. Inside UPF-Mini 420, four smaller rectangles are arranged vertically, each representing a specific function. From top to bottom, these functions are labeled: “Data Forwarding 422”, “QoS Enforcement 424”, “Traffic Shaping 426”, and “Packet Inspection 428”.

In some scenarios, the Data Forwarding 422 function may be responsible for efficiently routing user data packets through the network. By placing this function in the UPF-mini, data forwarding decisions may be made closer to the end-user, potentially reducing latency. The QoS Enforcement 424 function may apply the QoS policies defined by the UPF-core in real-time to user traffic. This local enforcement may ensure that latency-sensitive applications receive appropriate prioritization without the need to consult the centralized UPF-core for every decision.

Traffic Shaping 426 may control the rate of data flow through the network, potentially preventing congestion and ensuring fair resource allocation among users. The Packet Inspection 428 function may examine the contents of data packets in real-time, enabling advanced security features and application-aware networking without introducing significant delays.

Between UPF-Core 400 and UPF-Mini 420, a bi-directional arrow spanning the full height of the figure is labeled “Secure Communication Channel 430”. This channel may facilitate encrypted, low-latency communication between the centralized UPF-core 400 and the distributed UPF-mini 420 instances. The secure communication channel may enable the exchange of control information, policy updates, and performance data between the core and mini components.

At the bottom of FIG. 4, below both UPF-Core 400 and UPF-Mini 420, a horizontal rectangle spanning the full width of the figure is labeled “System-on-Chip (SoC) 440”. This SoC 440 may represent the hardware platform on which the UPF-mini 420 and other network functions are deployed at the enterprise premises. The integration of multiple network functions on a single SoC may offer benefits such as reduced hardware footprint, improved energy efficiency, and lower latency between components.

On the right side of FIG. 4, a bracket or brace encompasses UPF-Mini 420 and extends down to include SoC 440. This bracket is labeled “Enterprise Premises Deployment”, indicating that these components are typically located at the enterprise site. On the left side of the figure, a similar bracket encompasses UPF-Core 400 and is labeled “Centralized Deployment (On-Premises or Cloud)”. This labeling suggests that the UPF-core may be flexibly deployed either in a centralized on-premises data center or in a cloud environment, depending on the specific needs of the network operator or enterprise.

In other words, the braces in FIG. 4 illustrate two distinct deployment scenarios. The right-side brace, labeled “Enterprise Premises Deployment,” encompasses both the UPF-Mini 420 and the System-on-Chip (SoC) 440, indicating that these components are deployed together at the enterprise site. This configuration may enable low-latency processing close to the end-users. The left-side brace, labeled “Centralized Deployment (On-Premises or Cloud),” only encompasses the UPF-Core 400 and does not include the SoC. This brace suggests that the UPF-Core 400 may be deployed in a centralized manner, either in an on-premises data center or in a cloud environment, separate from the UPF-Mini 420 and SoC 440 at the enterprise premises. This arrangement maintains the disaggregation between the UPF-Core 400 and UPF-Mini 420 components, enabling flexible deployment options for the UPF-Core 400 while keeping the UPF-Mini 420 and SoC 440 at the enterprise edge.

In the space above UPF-Core 400, a small cloud shape labeled “To Core Network Functions” is shown, with an arrow drawn from this cloud to the top of UPF-Core 400. This connection may represent the UPF-core's interaction with other core network functions, such as the Session Management Function (SMF) or the Policy Control Function (PCF). In the space above UPF-Mini 420, a simplified antenna or tower shape labeled “To RAN” is depicted, with an arrow drawn from this shape to the top of UPF-Mini 420. This connection may illustrate the UPF-mini's close integration with Radio Access Network components, enabling low-latency processing of user plane data.

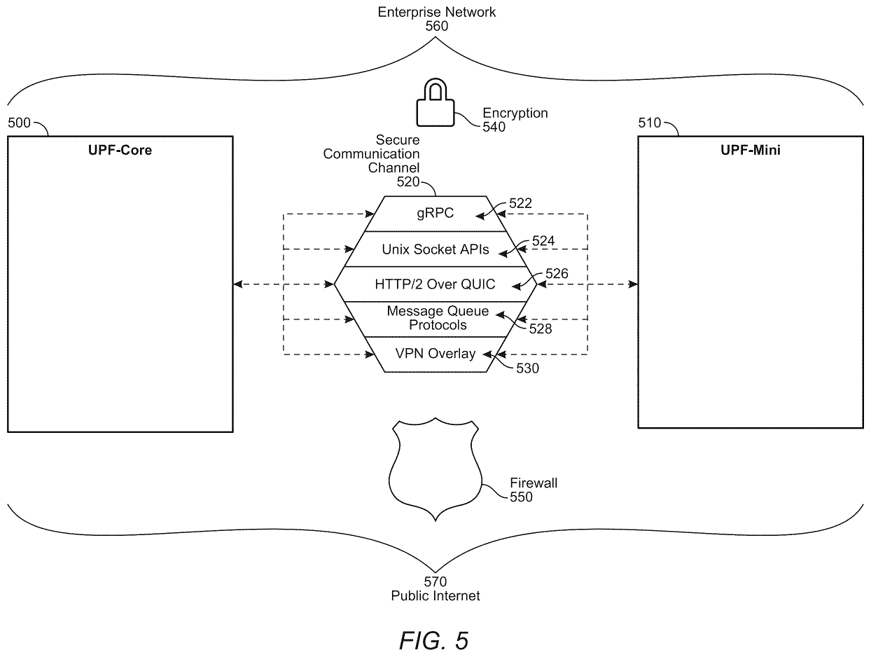

FIG. 5 illustrates a detailed view of an example secure communication channel between the UPF-core and UPF-mini components, highlighting various communication protocols and security measures. The figure presents a single, comprehensive panel that shows the communication infrastructure between these two components of the distributed UPF architecture. On the left side of FIG. 5, a large rectangle labeled “UPF-Core 500” may represent the centralized component of the User Plane Function, which may handle less latency-sensitive tasks and manage overall network policies. The placement of UPF-Core 500 on the left side of the figure may symbolize its role as the initiator or controller of many communication processes within the network. In some scenarios, the UPF-Core 500 may be responsible for tasks such as policy management, charging or billing operations, and overall coordination of multiple UPF-mini instances across different enterprise deployments. The centralized nature of UPF-Core 500 may enable more efficient resource utilization and simplified management of network-wide functions.

On the right side of FIG. 5, another large rectangle labeled “UPF-Mini 510” may represent the distributed component of the User Plane Function, designed to handle real-time, latency-sensitive tasks at the enterprise premises. The positioning of UPF-Mini 510 on the right side of the figure may indicate its role as the endpoint or executor of many network functions closer to the end-users. In some examples, UPF-Mini 510 may be responsible for tasks such as packet forwarding, Quality of Service (QoS) enforcement, and traffic shaping. By placing these functions closer to the network edge, the UPF-Mini 510 may help reduce latency and improve overall network performance for enterprise users. The distributed nature of UPF-Mini 510 may also enable better scalability and flexibility in network deployments, as additional instances may be added or removed based on specific enterprise needs.

In the center of FIG. 5, a large, elongated hexagon shape is labeled “Secure Communication Channel 520”. This hexagon may represent the robust and multi-faceted nature of the communication infrastructure between the UPF-Core and UPF-Mini. The use of a hexagon shape, rather than a simple line or rectangle, may suggest the complexity and layered security measures implemented in this communication channel. Inside the Secure Communication Channel 520, four horizontal lines are drawn, creating five sections within the hexagon. These sections represent different communication protocols that may be employed in the secure channel. From top to bottom, these sections are labeled: “gRPC 522”, “Unix Socket APIs 524”, “HTTP/2 over QUIC 526”, “Message Queue Protocols 528”, and/or “VPN Overlay 530”. This multi-protocol technique may provide flexibility and redundancy in the communication between UPF-Core 500 and UPF-Mini 510 components, enabling network operators to choose the most appropriate or preferred protocol for different types of data exchange or network conditions.

The gRPC 522 protocol may be used for efficient, language-agnostic remote procedure calls between the UPF-Core 500 and UPF-Mini 510. This protocol may be particularly useful for operations that involve structured data exchange, such as configuration updates or policy distributions. The use of gRPC may enable more efficient serialization and deserialization of data, potentially reducing bandwidth usage and improving communication speed. Additionally, gRPC's support for streaming may enable real-time updates and bi-directional communication between the UPF-Core 500 and UPF-Mini 510, which may be beneficial for scenarios requiring continuous data exchange or event-driven updates. The Unix Socket APIs 524 may provide high-performance inter-process communication, which may be beneficial when the UPF-Core 500 and UPF-Mini 510 are deployed on the same physical machine or in closely connected environments. This low-level communication method may offer minimal overhead and high throughput, making it suitable for scenarios where maximum performance is important. In some embodiments, Unix Socket APIs may be used for local communication within a single enterprise site, while other protocols may be employed for communication across different locations.

The HTTP/2 over QUIC 526 protocol may offer low-latency, multiplexed communication with built-in encryption. This protocol may be especially useful for scenarios where the UPF-Core and UPF-Mini exchange multiple streams of data concurrently, such as during complex network operations or when serving multiple user sessions simultaneously. The use of QUIC as the transport protocol may provide benefits such as improved connection establishment times and better performance in environments with packet loss. HTTP/2's multiplexing capabilities may enable more efficient use of network resources by sending multiple requests and responses over a single connection. Message Queue Protocols 528 may enable asynchronous communication between the UPF-Core 500 and UPF-Mini 510, which may be beneficial for non-real-time operations like logging, analytics, or batch processing of network data. These protocols may provide features such as message persistence, guaranteed delivery, and support for publish-subscribe patterns, which may enhance the reliability and scalability of the communication between UPF components. In some scenarios, message queue protocols may be used to decouple the UPF-Core 500 and UPF-Mini 510, enabling more resilient system architecture that may handle temporary network disruptions or component failures.

The VPN Overlay 530 at the bottom of the Secure Communication Channel 520 may provide an additional layer of security by creating an encrypted tunnel between the UPF-Core 500 and UPF-Mini 510. This overlay may ensure that communications, regardless of the specific protocol used, are protected from potential eavesdropping or tampering, especially when traversing public networks. The use of VPN technology may enable secure communication even when the UPF-Core 500 and UPF-Mini 510 are deployed in different physical locations or across different network domains. In some embodiments, the VPN Overlay may also provide features such as traffic prioritization or Quality of Service (QoS) guarantees, further enhancing the reliability and performance of the communication channel.

Bi-directional arrows are drawn from UPF-Core 500 to each section of the Secure Communication Channel 520, and then from each section to UPF-Mini 510. These arrows may represent the flow of data and control signals between the UPF-Core 500 and UPF-Mini 510 through the various communication protocols. The bi-directional nature of these arrows may indicate that communication flows in both directions, enabling for responsive and interactive operations between the core and mini components. This two-way communication may enable features such as real-time policy updates, dynamic resource allocation, and/or feedback loops for performance optimization. The use of multiple protocols, as represented by the different arrows, may provide redundancy and enable protocol selection based on the specific requirements of each type of communication.

Above the Secure Communication Channel 520, a small padlock icon labeled “Encryption 540” is shown. This icon may symbolize the encryption mechanisms applied to the communications between UPF-Core 500 and UPF-Mini 510, potentially including techniques such as TLS, IPsec, or application-level encryption. The presence of this encryption may help ensure the confidentiality and/or integrity of all data exchanged between the core and mini components. In some scenarios, different encryption methods may be applied to different types of data or communication protocols, enabling a balance between security and performance. The encryption mechanisms may also be designed to be flexible and upgradable, enabling network operators to adapt to evolving security standards and threats.

Below the Secure Communication Channel 520, a small shield icon labeled “Firewall 550” is depicted. This firewall representation may indicate the presence of security measures designed to filter and control the traffic between the UPF-Core 500 and UPF-Mini 510. Such firewalls may help protect against unauthorized access attempts and may enforce security policies specific to the UPF communication. In some embodiments, the firewall may include features such as deep packet inspection, intrusion detection and prevention, and application-aware filtering. The firewall may also be configurable to adapt to different security requirements or threat levels, providing network operators with more fine-grained control over the communication between UPF components.

At the top of FIG. 5, above UPF-Core 500 and UPF-Mini 510, a horizontal bracket spanning the entire width of the figure is labeled “Enterprise Network 560”. This bracket may indicate that the entire communication infrastructure operates within the context of an enterprise network environment, potentially with its own security perimeter and policies. The enterprise network context may influence aspects such as IP addressing, routing policies, and access controls for the UPF components. In some scenarios, the enterprise network may provide additional layers of security or monitoring that complement the specific security measures implemented in the Secure Communication Channel.

At the bottom of FIG. 5, below UPF-Core 500 and UPF-Mini 510, another horizontal bracket spanning the entire width of the figure is labeled “Public Internet 570”. This bracket may suggest that the secure communication channel is designed to operate safely even when traversing public internet infrastructure, which may be involved in scenarios where the UPF-Core 500 is deployed in a cloud environment while the UPF-Mini 510 remains on-premises. The inclusion of this public Internet layer in the figure may highlight the importance of robust security measures in the communication channel, as data may need to traverse potentially untrusted networks. In some embodiments, the communication between UPF-Core 500 and UPF-Mini 510 may use techniques such as tunneling, traffic obfuscation, or software-defined wide area network (SD-WAN) technologies to enhance security and reliability when operating over the public internet. The ability to securely communicate over public networks may provide greater flexibility in UPF deployments, potentially enabling more cost-effective and scalable network architectures.

In some examples, the multi-layered security technique illustrated in FIG. 5 may offer several benefits for enterprise 5G deployments. The combination of various communication protocols may enable network operators to optimize performance and security based on specific use cases or network conditions. For instance, latency-sensitive operations may utilize protocols like gRPC or Unix Socket APIs, while bulk data transfers or non-real-time operations may leverage HTTP/2 over QUIC or message queue protocols. This flexibility may enable more efficient use of network resources and better overall system performance. The inclusion of encryption and firewall components may provide defense-in-depth, potentially mitigating a wide range of security threats. The ability to operate securely over both enterprise networks and the public internet may facilitate hybrid deployment models, where some UPF components are hosted on-premises while others are deployed in cloud environments. This hybrid technique may offer a balance between the control and security of on-premises deployments and the scalability and cost-effectiveness of cloud-based solutions.

The architecture depicted in FIG. 5 may also support advanced networking concepts such as network slicing and edge computing. The secure communication channel may enable the creation of isolated, end-to-end network slices that span from the UPF-Core 500 to the UPF-Mini 510, potentially enabling customized network behaviors and Quality of Service (QoS) levels for different applications or user groups. In edge computing scenarios, the low-latency communication enabled by protocols like Unix Socket APIs or gRPC may facilitate rapid data exchange between edge-deployed UPF-Mini 510 instances and centralized UPF-Core components, potentially enabling more sophisticated edge processing capabilities and improved responsiveness for latency-sensitive applications. The flexibility and security of this communication infrastructure may also support emerging technologies such as AI-driven network optimization or automated security incident response, as it provides a robust foundation for exchanging complex control signals and large volumes of operational data between different parts of the network.

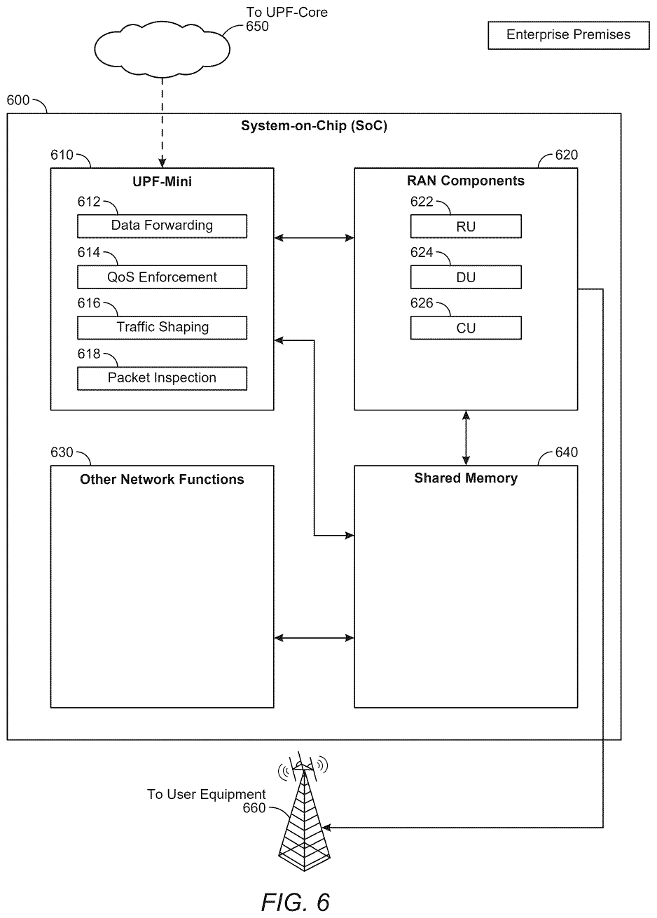

FIG. 6 illustrates a detailed view of an example UPF-mini's integration with RAN components on the System-on-Chip (SoC) and its real-time processing capabilities. The figure presents a single, comprehensive panel that clearly shows the internal architecture of the SoC and the interaction between its components. A large rectangle labeled “System-on-Chip (SoC) 600” represents the integrated hardware platform on which various network functions are deployed at the enterprise premises. The large size of the SoC 600 in the figure emphasizes its importance as a central element of the enterprise-side network architecture. The SoC 600 may integrate multiple network functions into a single, compact device, potentially reducing hardware footprint and improving energy efficiency. This integration may enable more efficient processing of network functions by reducing communication latency between components and enabling shared resources.

Inside SoC 600, four equally sized rectangles are arranged in a 2×2 grid. These rectangles represent different functional components integrated into the SoC. The top-left rectangle is labeled “UPF-Mini 610”, which handles real-time, latency-sensitive User Plane Function tasks. The UPF-Mini 610 may process user data packets, apply Quality of Service (QoS) policies, and perform other time-sensitive operations directly on the SoC. This placement of the UPF-Mini 610 on the SoC 600 may enable extremely low-latency processing of user plane data, potentially improving overall network performance and user experience. The top-right rectangle is labeled “RAN Components 620”, which manages Radio Access Network functions. By integrating RAN components 620 directly on the SoC 600 alongside the UPF-Mini 610, the system may achieve tighter coordination between radio access and user plane functions, potentially reducing latency and improving overall network efficiency.

The bottom-left rectangle is labeled “Other Network Functions 630”, which represents additional network capabilities integrated into the SoC 600. These other functions may include elements such as security features, edge computing resources, or specialized processing units for specific enterprise applications. The integration of these additional functions on the same SoC as the UPF-Mini and RAN components may enable for more comprehensive and efficient network processing at the enterprise edge. The bottom-right rectangle is labeled “Shared Memory 640”, which facilitates rapid data exchange between the different components on the SoC. This shared memory architecture may significantly reduce data transfer times between different network functions, potentially enabling more complex and responsive network operations.

Within the UPF-Mini 610 rectangle, four smaller rectangles are stacked vertically, each representing a specific function of the UPF-mini. From top to bottom, these functions are labeled: “Data Forwarding 612”, “QoS Enforcement 614”, “Traffic Shaping 616”, and “Packet Inspection 618”. These components work together to provide comprehensive, low-latency user plane functionality at the enterprise edge. The Data Forwarding 612 function may be responsible for efficiently routing user data packets through the network. By implementing this function directly on the SoC, data forwarding decisions may be made with minimal latency, potentially improving overall network performance. The QoS Enforcement 614 function may apply Quality of Service (QoS) policies in real-time to user traffic. This local enforcement may ensure that latency-sensitive applications receive appropriate prioritization without the need to consult a centralized component for every decision.

The Traffic Shaping 616 function may control the rate of data flow through the network, potentially preventing congestion and ensuring fair resource allocation among users. By performing traffic shaping on the SoC 600, network operators may achieve more granular and responsive control over data flows. The Packet Inspection 618 function may examine the contents of data packets in real-time, enabling advanced security features and application-aware networking without introducing significant delays. The integration of these functions within the UPF-Mini 610 on the SoC 600 may enable sophisticated traffic management and security measures to be applied at the network edge, potentially improving both performance and security for enterprise users.

Inside the RAN Components 620 rectangle, three smaller rectangles are stacked vertically, representing different elements of the Radio Access Network. From top to bottom, these are labeled: “RU 622”, “DU 624”, and “CU 626”. The RU 622 (Radio Unit) may handle the actual radio transmission and reception, converting between digital and analog signals. The DU 624 (Distributed Unit) may manage lower-layer processing of the radio access network protocols, while the CU 626 (Centralized Unit) may handle higher-layer processing. By integrating these RAN components 620 directly on the SoC 600 alongside the UPF-mini 610, the system may achieve tighter coordination between radio access and user plane functions, potentially reducing latency and improving overall network efficiency. This integration may also enable more flexible and efficient allocation of processing resources between RAN and UPF functions based on current network conditions and demands.

Bi-directional arrows connect various components within the SoC 600, illustrating the interactions between different functions. An arrow connects UPF-Mini 610 to RAN Components 620, which represents the close coordination between user plane and radio access functions. This direct connection may enable low-latency communication between UPF and RAN functions, potentially improving the responsiveness of the network for time-sensitive applications. Another arrow connects UPF-Mini 610 to Shared Memory 640, potentially enabling fast data access for user plane operations. This shared memory access may enable the UPF-Mini to quickly read and write data without the overhead of inter-process communication, further reducing processing latency.

A third arrow connects RAN Components 620 to Shared Memory 640, which may facilitate rapid exchange of radio network data. This connection may enable RAN components to quickly access and update network state information, potentially improving the coordination of radio resources. A fourth arrow connects Other Network Functions 630 to Shared Memory 640, enabling additional network functions to interact with the shared data pool. This shared memory architecture may enable efficient data sharing between all components on the SoC 600, potentially improving overall system performance and enabling more complex network operations at the edge.

At the top of the figure, above SoC 600, a small cloud shape labeled “To UPF-Core 650” is shown. A dashed arrow is drawn from this cloud to UPF-Mini 610, representing the connection between the on-premises UPF-mini and the centralized UPF-core. This connection may enable coordination between edge and core network functions, potentially enabling dynamic policy updates and centralized management. The dashed nature of the arrow may indicate that this connection operates over a network link, potentially with higher latency than the on-chip connections. This architectural choice may enable flexible deployment scenarios where the UPF-Core may be located either on-premises or in a cloud environment, while still maintaining efficient communication with the edge-deployed UPF-Mini.

At the bottom of the figure, below SoC 600, a simplified antenna or tower shape labeled “To User Equipment 660” is depicted. A solid arrow is drawn from RAN Components 620 to this antenna, representing the connection between the integrated RAN functions and end-user devices. This connection may enable low-latency communication between user equipment and the network edge, potentially improving the performance of latency-sensitive applications and services. The integration of RAN components 620 on the same SoC 600 as the UPF-Mini 610 may enable optimized handling of user traffic, potentially reducing the overall latency between user devices and the core network.

In the top-right corner of the figure, outside SoC 600, a text box with the label “Enterprise Premises” is added. This label emphasizes that the entire SoC-based architecture is deployed at the enterprise site, bringing advanced network functionality closer to the end-users. This edge deployment may offer several potential benefits, including reduced latency for enterprise applications, improved data privacy and security by processing sensitive information locally, and the ability to customize network behavior based on specific enterprise requirements.

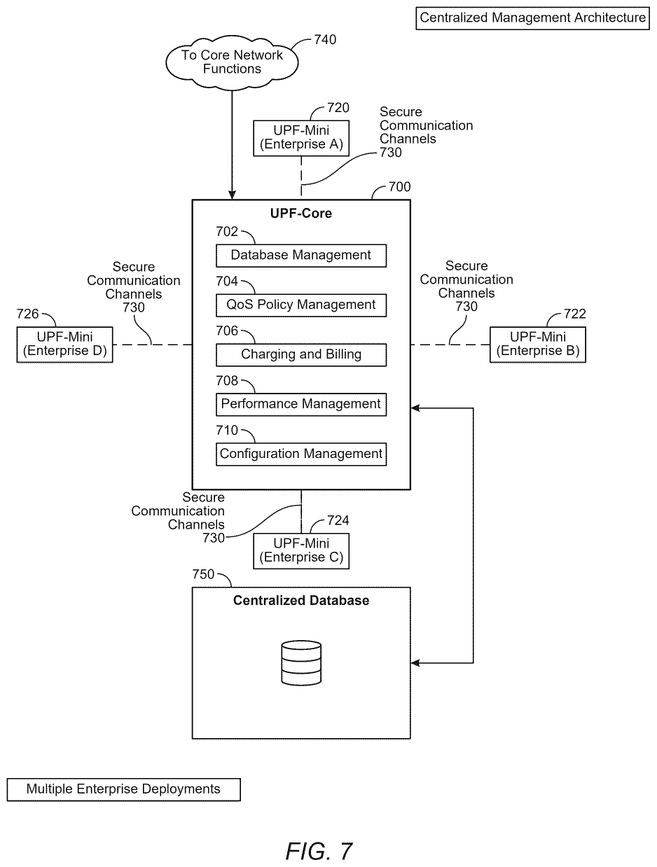

FIG. 7 illustrates a detailed view of the centralized management functions of the UPF-core and its interaction with multiple UPF-mini instances. The figure presents a single, comprehensive panel that shows the centralized nature of the UPF-core and its role in managing distributed UPF-mini deployments. At the center of the figure, a large rectangle labeled “UPF-Core 700” may represent the centralized component of the User Plane Function, which may handle less latency-sensitive tasks and manage overall network policies. The central placement of UPF-Core 700 in the figure may emphasize its role as the primary coordinator and manager of the distributed UPF architecture.

Inside UPF-Core 700, five smaller rectangles are stacked vertically, each representing a specific management function. From top to bottom, these functions are labeled: “Database Management 702”, “QoS Policy Management 704”, “Charging and Billing 706”, “Performance Management 708”, and “Configuration Management 710”. These components may work together to provide comprehensive management and control of the overall UPF system. The Database Management 702 function may be responsible for storing and managing subscriber data, session information, and other relevant network data. This centralized database management may enable efficient data retrieval and updates across the entire network, potentially improving overall system performance and consistency. The QoS Policy Management 704 function may define, store, and distribute Quality of Service (QoS) policies throughout the network. By centralizing this function, network operators may achieve consistent QoS enforcement across multiple UPF-mini instances and enterprise deployments, potentially leading to a more uniform user experience across different network segments.

The Charging and Billing 706 function within the UPF-Core 700 may handle the collection and processing of usage data for billing purposes. This centralized technique to charging and billing may simplify accounting processes and provide a unified view of network usage across multiple enterprise deployments. The centralization of this function may also enable more sophisticated billing models, such as multi-tenant or usage-based pricing schemes, which may be beneficial for enterprise customers with complex network specifications. Performance Management 708 may monitor and analyze the performance of both the UPF-core and distributed UPF-mini instances, potentially enabling proactive optimization of network resources. This function may collect performance metrics from across the network, analyze trends, and/or potentially trigger automated responses to maintain optimal network performance. The Configuration Management 710 function may manage the configuration settings for all UPF components, facilitating consistent setup and operation across the network. This centralized configuration management may simplify network administration and reduce the risk of configuration errors in large-scale deployments.

Around UPF-Core 700, four smaller rectangles are arranged in a circular pattern, equidistant from the center. These rectangles represent different UPF-mini instances deployed across various enterprise locations. They are labeled as follows: “UPF-Mini 720 (Enterprise A)” at the top, “UPF-Mini 722 (Enterprise B)” on the right, “UPF-Mini 724 (Enterprise C)” at the bottom, and “UPF-Mini 726 (Enterprise D)” on the left. This arrangement may illustrate the distributed nature of the UPF-mini deployments and their relationship to the centralized UPF-core. Each UPF-mini instance may handle real-time, latency-sensitive tasks at its respective enterprise location, while still maintaining a connection to the centralized UPF-core for management and coordination purposes.

This configuration may represent either four separate enterprise locations of a single organization or four distinct enterprises, each with its own UPF-Mini deployment. The flexibility of this architecture may enable both scenarios, as the centralized UPF-Core 700 may manage multiple UPF-Mini instances regardless of whether they belong to a single enterprise with multiple sites or to different enterprises entirely. In the case of a single enterprise with multiple locations, this setup may enable consistent policy enforcement and resource management across geographically distributed sites, while for separate enterprises, it may enable a network operator or service provider to efficiently manage and customize network services for multiple clients from a centralized platform.

Dashed lines connect UPF-Core 700 to each of the UPF-Mini instances (720, 722, 724, 726). These lines are collectively labeled as “Secure Communication Channels 730”. The use of dashed lines may indicate that these connections are logical or virtual, potentially operating over various physical network infrastructures. The secure nature of these communication channels may be helpful for maintaining the integrity or confidentiality of control messages and management data exchanged between the UPF-core and UPF-mini instances. These channels may support various management functions, such as policy distribution, performance monitoring, and configuration updates.

Above UPF-Core 700, a small cloud shape labeled “To Core Network Functions 740” is shown. A solid arrow is drawn from “To Core Network Functions 740” to UPF-Core 700. This connection may represent the UPF-core's interaction with other core network functions, such as the Session Management Function (SMF) or the Policy Control Function (PCF). The solid arrow may indicate a more direct or permanent connection compared to the dashed lines connecting to the UPF-mini instances. This interaction with core network functions may enable the UPF-core to coordinate its actions with the broader network ecosystem, potentially ensuring consistent policy enforcement and efficient resource allocation across the entire network.

Below UPF-Core 700, a rectangle with a database icon inside is labeled “Centralized Database 750”. A bi-directional arrow connects UPF-Core 700 and Centralized Database 750. This centralized database may store various types of network data, potentially including subscriber information, session data, network configuration settings, and/or historical performance metrics. The bi-directional arrow may indicate that the UPF-core both reads from and writes to this database, potentially enabling real-time updates and data-driven decision making. The centralization of this database may enable more efficient data management and analysis across the entire UPF deployment.

In the top-right corner of the figure, a text box with the label “Centralized Management Architecture” is added. This label may emphasize the overall design philosophy illustrated in the figure, highlighting the centralized nature of certain management functions within the UPF-core. This centralized management architecture may offer several potential benefits, including simplified administration, consistent policy enforcement, and/or improved visibility into network-wide operations. In some scenarios, this architecture may enable more efficient resource allocation and faster response to changing network conditions by centralizing decision-making processes.

In the bottom-left corner of the figure, another text box with the label “Multiple Enterprise Deployments” is added. This label may underscore the scalability of the architecture, illustrating how a single UPF-core may manage multiple UPF-mini instances across different enterprise locations. This distributed deployment model may offer benefits such as improved performance for local traffic, enhanced reliability through geographical distribution, and the ability to tailor network configurations to specific enterprise requests while maintaining centralized control and oversight.

In some examples, this centralized management architecture may support advanced network features such as network slicing or differentiated service levels for various enterprise customers. The UPF-core may dynamically allocate resources and adjust policies across multiple UPF-mini instances to create isolated network slices or to meet specific service level agreements. The centralized nature of certain management functions may also facilitate more efficient embodiment of network-wide updates or security patches, potentially improving the overall agility and security posture of the network. Additionally, the aggregation of data from multiple UPF-mini instances at the UPF-core may enable more sophisticated analytics and machine learning applications, potentially leading to predictive maintenance, automated optimization, and improved network planning capabilities.

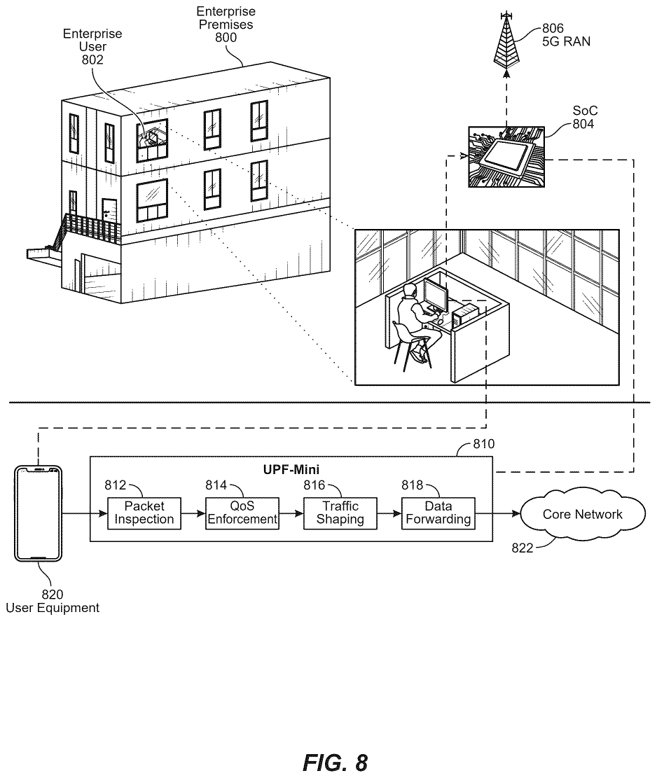

FIG. 8 illustrates a detailed view of the UPF-mini's integration in an enterprise environment and its real-time processing capabilities. The figure is divided into two main sections: the top half represents the physical enterprise environment, while the bottom half shows a schematic representation of the data flow through the UPF-mini.

In the top half of FIG. 8, on the left side, a detailed office building labeled “Enterprise Premises 800” is shown. This representation may symbolize a typical enterprise location where 5G network services are implemented. Inside the building, a person sitting at a desk with a computer is shown, labeled “Enterprise User 802”. This depiction may illustrate the end-user perspective and the importance of providing connectivity within the enterprise environment. The presence of the enterprise user may emphasize the need for low-latency, high-performance network services to support various business applications and communications.

On the right side of the building, a sleek, modern-looking device representing the System-on-Chip is depicted, labeled “SoC 804”. This SoC 804 may integrate multiple network functions into a single, compact device, potentially reducing hardware footprint and improving energy efficiency within the enterprise premises. The placement of the SoC 804 within Enterprise Premises 800 may highlight the edge computing capabilities of this architecture, bringing advanced network processing closer to the end-users. Above the SoC 804, a simplified cellular tower labeled “5G RAN 806” is shown. This representation may indicate the integration of Radio Access Network components with the UPF-mini on the same SoC, potentially enabling tighter coordination between radio access and user plane functions.

Dashed lines connect the user's computer to the SoC 804, and another dashed line connects the SoC 804 to the cellular tower. These connections may represent the flow of data from the enterprise user through the local network infrastructure and out to the broader cellular network. The use of dashed lines may suggest the logical or virtual nature of these connections, which may be implemented through various physical network technologies.

In the bottom half of FIG. 8, a large rectangle is labeled “UPF-Mini 810” and may illustrate the internal functions and data flow within the UPF-mini 810 deployed on the SoC 804. Inside UPF-Mini 810, four smaller rectangles are arranged in a row, labeled from left to right: “Packet Inspection 812”, “QoS Enforcement 814”, “Traffic Shaping 816”, and “Data Forwarding 818”. These components may work together to provide comprehensive, low-latency user plane functionality at the enterprise edge.

Arrows connecting these rectangles in the order listed above may represent the typical flow of data through the UPF-mini 810. This sequential processing may enable efficient handling of user traffic, with each stage building upon the results of the previous one. The Packet Inspection 812 function may examine the contents of data packets in real-time, enabling advanced security features and application-aware networking without introducing significant delays. This function may be particularly helpful for enterprises with strict security requirements or those implementing sophisticated traffic management policies.

The QoS Enforcement 814 function may apply Quality of Service (QoS) policies in real-time to user traffic. This local enforcement may help facilitate latency-sensitive applications receiving appropriate prioritization without the need to consult a centralized component for every decision. By performing QoS enforcement at the edge, the system may provide more responsive and tailored service quality for different enterprise applications. The Traffic Shaping 816 function may control the rate of data flow through the network, potentially preventing congestion and ensuring fair resource allocation among users. This function may be particularly valuable in enterprise environments where multiple users or applications may compete for network resources.

The Data Forwarding 818 function may be responsible for efficiently routing user data packets through the network. By implementing this function directly on the SoC 804, data forwarding decisions may be made with minimal latency, potentially improving overall network performance. The proximity of this function to the enterprise users may result in faster response times for local traffic and more efficient utilization of network resources.

On the far left of the bottom half, a smartphone icon labeled “User Equipment 820” is shown. This representation may symbolize the various mobile devices that enterprise users may employ to connect to the network. The placement of this icon at the beginning of the data flow may indicate that the UPF-mini processes traffic originating from or destined for these user devices. On the far right of the bottom half, a cloud shape labeled “Core Network 822” is depicted. This cloud may represent the broader network infrastructure beyond the enterprise premises, potentially including centralized UPF-core components and other core network functions.

An arrow is drawn from User Equipment 820 to Packet Inspection 812, and another arrow from Data Forwarding 818 to Core Network 822. These arrows may illustrate the general flow of data through the UPF-mini 810, from user devices through the various processing stages and ultimately to the core network or vice versa. This representation may emphasize the role of the UPF-mini 810 as an intermediary between enterprise users and the broader network infrastructure, providing local processing and optimization of user traffic.

In some examples, this integration of UPF-mini functions within the enterprise environment may offer several potential benefits. The close proximity of UPF processing to end-users may result in lower latency for enterprise applications, potentially improving the performance of time-sensitive services such as video conferencing or real-time data analytics. The ability to perform packet inspection and QoS enforcement at the edge may enable more granular and responsive network management, enabling enterprises to tailor their network behavior to specific application requirements or security policies. Additionally, the collocation of UPF-mini functions with RAN components on the same SoC may facilitate tighter integration between radio access and core network functions, potentially leading to more efficient use of radio resources and improved overall network performance.

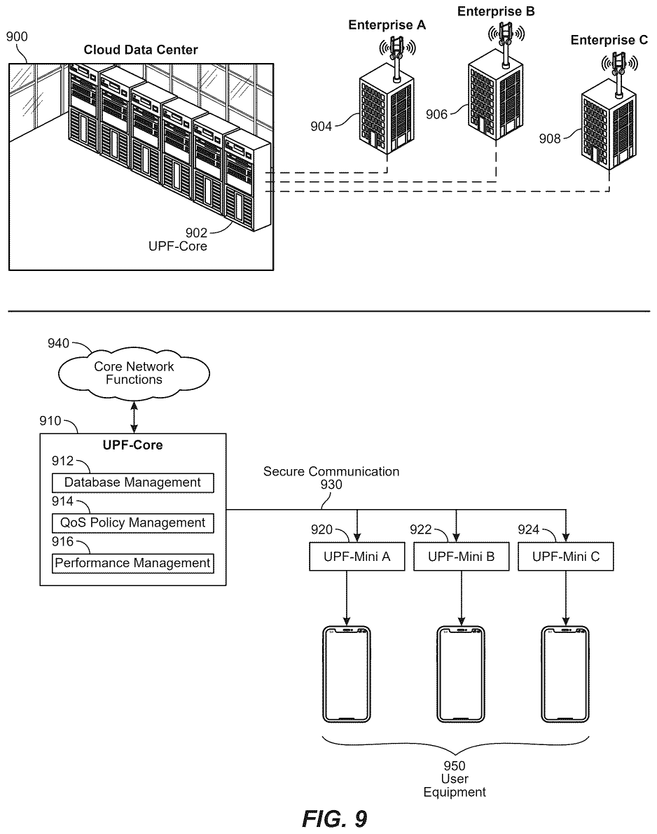

FIG. 9 illustrates a comprehensive view of an example interaction between the UPF-core and multiple UPF-mini instances across different enterprise deployments. The figure is divided into two main sections: the top half represents the physical deployment scenario, while the bottom half shows a schematic representation of the data and control flow.

In the top half of FIG. 9, on the left side, a large, modern data center building is shown, labeled “Cloud Data Center 900”. This Cloud Data Center 900 may represent a centralized location where core network functions, including the UPF-core, are hosted. The use of a cloud data center for hosting the UPF-core may offer benefits such as scalability, easier maintenance, and potentially reduced infrastructure costs for network operators. Inside the data center, a rack of servers is depicted, with one of the servers labeled “UPF-Core 902”. This UPF-Core 902 may handle less latency-sensitive tasks and manage overall network policies for multiple enterprise deployments. The centralized nature of UPF-Core 902 may enable efficient resource utilization and simplified management of network-wide functions.

On the right side of the top half, three smaller office buildings are drawn in a row, labeled “Enterprise A 904”, “Enterprise B 906”, and “Enterprise C 908” from left to right. These buildings may represent different enterprise locations or separate enterprises, each with its own UPF-mini deployment. The depiction of multiple enterprise buildings may illustrate the scalability of this architecture and its ability to support diverse deployment scenarios. On top of each enterprise building, a small cellular tower is shown to represent 5G coverage. These cellular towers may indicate that each enterprise location has its own radio access network capabilities, potentially integrated with the local UPF-mini deployment.

Dashed lines connect the UPF-Core 902 to each of the enterprise buildings, representing network connections. These connections may symbolize the secure communication channels between the centralized UPF-core and the distributed UPF-mini instances at each enterprise location. The use of dashed lines may suggest that these are logical or virtual connections that may be implemented over various physical network infrastructures.

In the bottom half of FIG. 9, a large rectangle on the left side is labeled “UPF-Core 910”. This schematic representation of the UPF-core may illustrate its key functions and its role in managing multiple UPF-mini instances. Inside UPF-Core 910, three smaller rectangles are stacked vertically, labeled from top to bottom: “Database Management 912”, “QoS Policy Management 914”, and “Performance Management 916”. These components may work together to provide comprehensive management and control of the overall UPF system across multiple enterprise deployments.

The Database Management 912 function may be responsible for storing and managing subscriber data, session information, and/or other relevant network data across all connected enterprises. This centralized database management may enable efficient data retrieval and updates across the entire network, potentially improving overall system performance and consistency. The QoS Policy Management 914 function may define, store, and distribute Quality of Service (QoS) policies throughout the network. By centralizing this function, network operators may achieve consistent QoS enforcement across multiple UPF-mini instances and enterprise deployments, potentially leading to a more uniform user experience across different network segments. The Performance Management 916 function may monitor and analyze the performance of both the UPF-core and distributed UPF-mini instances, potentially enabling proactive optimization of network resources across all connected enterprises.

On the right side of the bottom half, three smaller rectangles in a row represent UPF-mini instances. These are labeled “UPF-Mini A 920”, “UPF-Mini B 922”, and “UPF-Mini C 924” from left to right. Each of these UPF-mini instances may correspond to one of the enterprise buildings shown in the top half of the figure. The UPF-mini instances may handle real-time, latency-sensitive tasks at their respective enterprise locations, while still maintaining a connection to the centralized UPF-core for management and coordination purposes.

Arrows connecting UPF-Core 910 to each UPF-Mini instance are collectively labeled as “Secure Communication 930”. These arrows may represent the logical connections between the UPF-core and UPF-mini instances, potentially carrying control messages, policy updates, and/or management data. The secure nature of these communication channels may be helpful for maintaining the integrity and confidentiality of data exchanged between the core and edge components of the network.

Above UPF-Core 910, a cloud shape labeled “Core Network Functions 940” is shown. A bidirectional arrow connects Core Network Functions 940 and UPF-Core 910. This connection may represent the UPF-core 910 interaction with other core network functions, such as the Session Management Function (SMF) or the Policy Control Function (PCF). The bidirectional nature of the arrow may indicate that the UPF-core 910 both receives instructions from and provides feedback to these core network functions, enabling coordinated network management.

Below each UPF-Mini instance, simplified smartphone icons are shown, collectively labeled as “User Equipment 950”. Arrows are drawn from each UPF-Mini instance to its corresponding User Equipment 950. These connections may illustrate the role of UPF-mini instances in processing user traffic at the enterprise edge, potentially providing low-latency services to end-user devices. The placement of User Equipment 950 below the UPF-mini instances may emphasize the local nature of these connections and the potential for improved performance due to edge processing.

In some examples, this architecture may offer several potential benefits for large-scale enterprise 5G deployments. The centralized UPF-core may enable efficient management of network resources across multiple enterprise locations, potentially simplifying administration and reducing operational costs. The distributed UPF-mini instances (920, 922, 924) may provide localized processing capabilities, potentially reducing latency for enterprise applications and improving overall network performance. The secure communication channels between the UPF-core 910 and UPF-mini instances (920, 922, 924) may enable flexible deployment scenarios, where enterprises may maintain local control over their network functions while still benefiting from centralized management and policy enforcement.

The above discussion provided an overview of the figures. Additionally, the following provides further discussion of related concepts and/or more concrete or detailed embodiments.

In some examples, the disaggregated UPF architecture may offer significant scalability benefits for multiple enterprise deployments. This scalability may be achieved through the centralized management capabilities of the UPF-core 910 combined with the distributed processing power of multiple UPF-mini instances (920, 922, 924). The UPF-core 910 may be designed to handle an increasing number of UPF-mini instances (920, 922, 924) without substantial degradation in performance, potentially enabling network operators to expand their service offerings to a growing number of enterprises. This scalability may be facilitated by the modular nature of the architecture, where additional UPF-mini instances (920, 922, 924) may be deployed and integrated with the existing UPF-core 910 as new enterprise customers are onboarded. The centralized UPF-core 910 may utilize advanced load balancing algorithms to distribute processing tasks and network resources efficiently across multiple UPF-mini instances (920, 922, 924), potentially ensuring optimal performance even as the number of connected enterprises grows.

The scalability of this architecture may also extend to the management of network policies and configurations across multiple enterprises. The UPF-core 910 may maintain a centralized repository of network policies, QoS rules, and configuration parameters, which may be dynamically distributed to the appropriate UPF-mini instances (920, 922, 924) as appropriate. This centralized management technique may significantly reduce the complexity of managing large-scale, multi-enterprise deployments, as updates and changes may be propagated from a single point of control. Additionally, the architecture may support multi-tenancy, enabling the UPF-core 910 to maintain logical separation between different enterprise customers while sharing physical infrastructure. This multi-tenant capability may enable network operators to offer customized services to each enterprise while maximizing resource utilization across the entire network. The scalability of the system may also be enhanced by the potential integration with cloud-based resources, enabling dynamic expansion of processing capacity to handle peak loads or sudden increases in the number of connected enterprises.

In some scenarios, the disaggregated UPF architecture may be designed to seamlessly integrate with existing enterprise IT systems, potentially providing a smooth transition path for businesses adopting 5G technology. This integration may be facilitated by the deployment of UPF-mini instances (920, 922, 924) on-premises, which may enable direct connectivity with legacy enterprise networks and applications. Each UPF-mini may be equipped with various interface adapters and protocol converters, enabling it to communicate with a wide range of enterprise systems, including legacy databases, enterprise resource planning (ERP) software, customer relationship management (CRM) tools, and/or industry-specific applications. This integration capability may enable enterprises to leverage their existing IT investments while benefiting from the advanced capabilities of 5G networks, potentially reducing the overall cost and complexity of network upgrades.

The integration between the disaggregated UPF and enterprise IT systems may extend beyond mere connectivity. In some embodiments, the UPF-mini may be designed to support application programming interfaces (APIs) that enable deep integration with enterprise workflows and business processes. For example, a UPF-mini may expose APIs for real-time network performance data, enabling enterprise IT systems to make intelligent decisions based on current network conditions. Similarly, enterprise applications may use these APIs to request specific QoS levels or network slices for critical operations. The UPF-core 910 may also play a role in this integration by providing centralized management of enterprise-specific network policies and configurations. This centralized technique may enable network administrators to align network behavior with enterprise IT policies and security requirements, potentially ensuring consistent performance and compliance across the entire organization. Additionally, the integration capabilities of the disaggregated UPF architecture may extend to support for enterprise identity and access management systems, enabling seamless and secure authentication of users and devices across both the enterprise IT environment and the 5G network.

In some examples, the transition from a traditional, monolithic UPF to the disaggregated UPF architecture may be implemented through a planned migration path. This migration technique may enable network operators and enterprises to gradually adopt the new architecture without disrupting existing services or requiring a complete overhaul of their network infrastructure. The migration process may begin with the deployment of the UPF-core 910 alongside the existing monolithic UPF, potentially running in parallel to ensure continuity of service. During this initial phase, the UPF-core 910 may be configured to handle a subset of network functions, such as policy management or charging, while the legacy UPF continues to manage the majority of user plane traffic. This parallel operation may enable network operators to validate the performance and reliability of the UPF-core 910 before proceeding with further migration steps. As confidence in the new architecture grows, additional functions may be gradually transferred from the legacy UPF to the UPF-core 910, potentially following a phased technique that prioritizes less critical functions first.

The introduction of UPF-mini instances (920, 922, 924) may represent the next phase in the migration process. These instances may be deployed incrementally, potentially starting with a single enterprise location or a small group of test sites. The UPF-mini instances (920, 922, 924) may initially operate in a hybrid mode, where they handle a portion of the user plane traffic while still relying on the legacy UPF for certain functions. This hybrid operation may enable a smooth transition and provide opportunities for performance comparison between the new and old architectures. As the UPF-mini instances (920, 922, 924) prove their reliability and efficiency, more traffic may be gradually shifted away from the legacy UPF. The migration technique may also involve the development of interworking functions or gateways that facilitate communication between the disaggregated UPF components and legacy network elements. These interworking functions may help ensure backward compatibility and enable for a more flexible migration timeline. Throughout the migration process, network operators may leverage the centralized management capabilities of the UPF-core 910 to monitor the performance of both the legacy and new components, potentially enabling data-driven decisions about the pace and scope of the migration.

In some scenarios, the disaggregated UPF architecture may offer robust support for Internet of Things (IoT) and industrial applications, potentially enabling a wide range of new use cases in the 5G era. The flexible nature of this architecture may enable the efficient handling of the diverse requirements of IoT devices, which may range from low-bandwidth, long-battery-life sensors to high-bandwidth, low-latency industrial control systems. The UPF-mini, deployed on-premises, may play a role in supporting IoT applications by providing localized processing and reduced latency for time-sensitive operations. This edge processing capability may be particularly beneficial for industrial IoT applications, such as real-time monitoring and control of manufacturing processes, where even minor delays may have significant consequences. The UPF-mini may be equipped with specialized packet processing capabilities tailored to the unique characteristics of IoT traffic, potentially optimizing network performance for large numbers of connected devices with intermittent communication patterns.

The UPF-core 910, in turn, may provide centralized management and orchestration capabilities that are used for large-scale IoT deployments. It may handle tasks such as device authentication, security policy enforcement, and/or data aggregation for IoT applications that span multiple enterprise locations. The UPF-core 910 may also facilitate the embodiment of network slicing, a technique that may be particularly valuable for IoT and industrial applications. Network slicing may enable the creation of virtual, isolated network segments with tailored characteristics for different types of IoT devices or industrial processes. For example, a network slice for critical industrial control systems may be configured with ultra-low latency and high reliability, while another slice for environmental sensors may prioritize energy efficiency and wide coverage. The disaggregated UPF architecture may enable fine-grained control over these network slices, potentially enabling dynamic adjustment of slice parameters based on changing application requirements or network conditions. Additionally, the architecture may support edge computing paradigms that are often essential for IoT and industrial applications, potentially enabling data processing and analysis closer to the point of data generation and reducing the need for constant communication with centralized cloud servers.

In some examples, the disaggregated UPF architecture may employ sophisticated techniques for dynamic resource allocation based on real-time traffic patterns. This capability may be particularly valuable in enterprise environments where network demands may fluctuate significantly throughout the day or in response to specific events. The UPF-core 910 may play a central role in this dynamic resource allocation by continuously analyzing traffic data from multiple UPF-mini instances (920, 922, 924) and other network elements. Advanced machine learning algorithms implemented in the UPF-core 910 may identify patterns or trends in network usage, potentially enabling predictive resource allocation. For instance, the system may learn that certain enterprise applications generate high-bandwidth traffic during specific hours of the day and preemptively allocate additional resources to the relevant UPF-mini instances (920, 922, 924). This proactive technique may help prevent performance degradation and help ensure a consistent user experience even during peak usage periods.

The dynamic resource allocation capability may extend beyond simple bandwidth management to encompass a wide range of network resources. Processing power, memory allocation, and even the number of active network slices may be dynamically adjusted based on real-time traffic patterns. The UPF-mini instances (920, 922, 924) may be designed with a degree of elasticity, enabling them to scale their capabilities up or down in response to instructions from the UPF-core. This elasticity may be achieved through techniques such as dynamic instantiation of virtual network functions or reallocation of processing cores within the System-on-Chip (SoC). In scenarios where local resources are insufficient to meet demand, the UPF-core 910 may orchestrate the offloading of certain functions to cloud resources or neighboring UPF-mini instances (920, 922, 924), potentially ensuring seamless service continuity. The dynamic nature of this resource allocation may also contribute to improved energy efficiency, as resources may be scaled down during periods of low demand, potentially reducing power consumption and operational costs for enterprises.

In some scenarios, the disaggregated UPF architecture may incorporate robust multi-access edge computing (MEC) capabilities, potentially enabling a new class of low-latency, high-bandwidth applications at the enterprise edge. The UPF-mini, deployed on a System-on-Chip (SoC) at the enterprise premises, may serve as an ideal platform for MEC functionality, providing compute and storage resources in close proximity to end-users and IoT devices. This edge computing capability may be tightly integrated with the user plane functions, potentially enabling efficient processing of data traffic without the need to backhaul all traffic to centralized data centers. The MEC platform within the UPF-mini may host a variety of applications and services, ranging from real-time video analytics and augmented reality support to local breakout for enterprise applications. By processing data at the edge, the system may significantly reduce latency for time-sensitive applications while also potentially reducing bandwidth consumption on the wider network.

The integration of MEC capabilities with the disaggregated UPF architecture may offer several unique advantages. The UPF-core may play a role in orchestrating and managing MEC resources across multiple enterprise locations, potentially enabling seamless migration of edge applications based on user mobility or changing network conditions. This centralized management may also facilitate the dynamic deployment of new edge applications or services, potentially enabling enterprises to rapidly innovate and deploy new capabilities without significant infrastructure changes. The MEC platform may leverage the UPF-mini's deep integration with radio access network (RAN) components to provide applications with real-time radio network information, potentially enabling highly optimized and context-aware services. For example, an augmented reality application hosted on the MEC platform may use real-time information about radio conditions to adapt its content delivery, ensuring a smooth user experience even in challenging network environments. Additionally, the MEC capabilities may enhance the network's ability to support advanced IoT and industrial applications by providing local processing for data aggregation, filtering, and analysis, potentially reducing the volume of data that needs to be transmitted to cloud-based systems.

In some examples, the disaggregated UPF architecture may deeply integrate artificial intelligence (AI) and machine learning (ML) techniques for comprehensive network optimization. This integration may occur at multiple levels within the architecture, potentially enabling more intelligent, adaptive, and/or efficient network operations. At the UPF-core level, AI/ML algorithms may be employed for a wide range of tasks, including predictive maintenance, anomaly detection, and advanced traffic forecasting. These algorithms may analyze vast amounts of data collected from UPF-mini instances and other network elements, potentially identifying patterns and trends that would be difficult or impossible to detect through other rule-based systems. For instance, ML models may be trained to predict potential network failures or performance degradations before they occur, enabling proactive maintenance and minimizing service disruptions. The AI-driven UPF-core may also optimize resource allocation across the network, dynamically adjusting parameters such as computing power, memory allocation, and/or network slice configurations based on learned patterns and/or real-time conditions.

At the UPF-mini level, AI/ML techniques may be employed for more localized optimization tasks. Edge AI capabilities integrated into the UPF-mini may enable real-time decision making for latency-sensitive applications, potentially improving the performance of services such as autonomous vehicles or industrial control systems. These edge AI models may be continuously updated and fine-tuned based on local conditions, potentially providing highly contextualized and efficient network services. The integration of AI/ML may also extend to the security domain, with machine learning models potentially detecting and mitigating security threats in real-time at both the edge and core levels. Additionally, the disaggregated UPF architecture may serve as a platform for AI/ML-driven network automation. Reinforcement learning techniques, for example, may be used to develop self-optimizing networks that continuously adapt to changing conditions without human intervention. This high degree of automation may significantly reduce operational costs and improve overall network reliability. The AI/ML integration may also facilitate more sophisticated Quality of Service (QoS) management, with intelligent algorithms dynamically adjusting QoS parameters based on application requirements, user behavior, and network conditions.

In some scenarios, the disaggregated UPF architecture may provide robust support for network function virtualization (NFV), potentially enabling greater flexibility, scalability, and cost-effectiveness in network deployments. The UPF-core, in particular, may be designed to operate as a fully virtualized network function, capable of running on standard commercial off-the-shelf (COTS) hardware or in cloud environments. This virtualization may enable network operators to dynamically allocate resources to the UPF-core based on demand, potentially improving resource utilization and reducing hardware costs. The virtualized UPF-core may be easily scaled up or down, and multiple instances may be deployed across different geographic locations for improved redundancy and performance. Moreover, the NFV support may extend to the creation of virtual UPF-mini instances, which may be deployed alongside physical instances to handle overflow traffic or to provide services in locations where physical deployment is not feasible.

The integration of NFV capabilities within the disaggregated UPF architecture may also facilitate more advanced network management techniques. For example, the system may support the concept of UPF-as-a-Service, where UPF functionality may be dynamically instantiated and configured on-demand to meet specific enterprise requirements. This service-based technique may enable more granular control over network resources and may enable new business models for network operators. The NFV support may also enhance the system's ability to integrate with broader network orchestration platforms, potentially enabling end-to-end service creation and management across multiple network domains. In some embodiments, the disaggregated UPF architecture may leverage container technologies for virtualizing network functions, potentially offering benefits such as faster startup times, lower overhead, and/or improved resource isolation compared to traditional virtual machines. This containerized technique may be particularly beneficial for edge deployments, where resources may be more constrained. Additionally, the NFV capabilities may facilitate easier software updates and patching, as new versions of network functions may be deployed and tested in isolated environments before being rolled out to production.

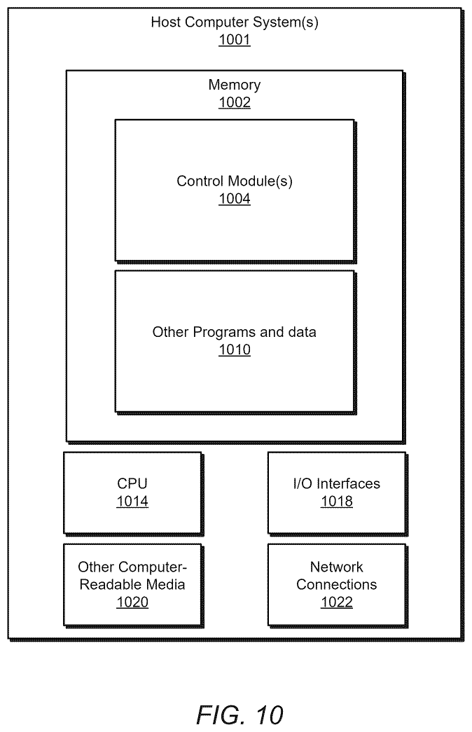

FIG. 10 shows a system diagram that describes an example embodiment of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 10 illustrates an example of underlying hardware on which such software and functionality may be hosted and/or implemented.

In particular, shown is example host computer system(s) 1001. For example, such computer system(s) 1001 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems or components described herein. Memory 1002 may also store other programs and data 1010, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network;
deploying the UPF-core in a centralized location; and
deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

2. The method of claim 1, further comprising deploying the UPF-core on-premises at the enterprise premises such that both the UPF-core and UPF-mini are located at the enterprise premises.

3. The method of claim 1, further comprising deploying the UPF-core in a cloud computing environment such that the UPF-core operates as a virtualized network function.

4. The method of claim 1, further comprising implementing a secure communication channel between the UPF-core and the UPF-mini through at least one of gRPC, Unix Socket APIs, HTTP/2, or VPN overlays.

5. The method of claim 4, further comprising utilizing the secure communication channel to synchronize configuration data between the UPF-core and the UPF-mini.

6. The method of claim 4, further comprising employing the secure communication channel to transmit performance metrics or fault data from the UPF-mini to the UPF-core for centralized analysis.

7. The method of claim 1, further comprising implementing a database management system in the UPF-core that stores or manages subscriber or session-related data for multiple UPF-minis.

8. The method of claim 1, further comprising centralizing Quality of Service (QoS) policy management in the UPF-core such that a QoS rule is distributed to multiple UPF-minis for enforcement.

9. The method of claim 1, further comprising implementing a centralized charging or billing system in the UPF-core that collects usage data from multiple UPF-minis and interfaces with a Charging Function (CHF).

10. The method of claim 1, further comprising deploying a performance management system in the UPF-core that monitors a performance metric from multiple UPF-minis for analysis and troubleshooting.

11. The method of claim 1, further comprising implementing a fault management system in the UPF-core that tracks or manages a set of errors, outages, or faults that is reported from a set of multiple UPF-minis.

12. The method of claim 1, further comprising centralizing configuration management in the UPF-core such that configuration parameters are distributed to multiple UPF-minis.

13. The method of claim 1, further comprising implementing a data forwarding or routing function in the UPF-mini such that delay in user traffic delivery is reduced.

14. The method of claim 1, further comprising implementing a Quality of Service (QoS) enforcement function in the UPF-mini such that traffic is prioritized based on a service requirement.

15. The method of claim 1, further comprising implementing a traffic shaping or rate limiting function in the UPF-mini such that data flow or match bandwidth allowances are controlled.

16. The method of claim 1, further comprising implementing a packet inspection or filtering function in the UPF-mini such that deep packet inspection is performed for security, compliance, or service-based filtering.

17. A non-transitory computer-readable medium that has instructions stored thereon that, when executed by at least one physical computing processor, cause a computing device to perform operations comprising:
obtaining both a User Plane Function (UPF)-core that handles a first set of UPF functions that are less latency-sensitive than a second set of UPF functions and a UPF-mini that handles the second set of UPF functions that are more latency-sensitive than the first set such that the UPF-core and the UPF-mini partition a UPF of at least a fifth-generation cellular network;
deploying the UPF-core in a centralized location; and
deploying the UPF-mini on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

18. The non-transitory computer-readable medium of claim 17, wherein the operations further comprise deploying the UPF-core on-premises at the enterprise premises such that both the UPF-core and UPF-mini are located at the enterprise premises.

19. A system comprising:
a User Plane Function (UPF)-core that handles a first set of UPF functions that are less latency-sensitive than a second set of UPF functions; and
a UPF-mini that handles the second set of UPF functions that are more latency-sensitive than the first set such that the UPF-core and the UPF-mini partition a UPF of at least a fifth-generation cellular network;
wherein:
the UPF-core is deployed in a centralized location; and
the UPF-mini is deployed on a System-on-a-Chip (SoC) at an enterprise premises of an enterprise such that the UPF-mini is connected to the UPF-core and Radio Access Network (RAN) components on the SoC in a manner that provides at least fifth-generation cellular service to the enterprise.

20. The system of claim 19, wherein the UPF-core is deployed on-premises at the enterprise premises such that both the UPF-core and UPF-mini are located at the enterprise premises.
